(19) United States
(12) Patent Application Publication
(10) Pub. No.: US 2026/0057370 A1
(43) Pub. Date: Feb. 26, 2026

(54) CONTEXT-AWARE IMAGE GENERATION SYSTEM AND METHOD THEREFOR

(71) Applicant: Visa International Service Association, San Francisco, CA (US)

(72) Inventors: Debdeep Bandyopadhyay, Durgapur (IN); Shivam Mohan, Lucknow (IN)

(73) Assignee: Visa International Service Association, San Francisco, CA (US)

(21) Appl. No.: 18/815,628

(22) Filed: Aug. 26, 2024

(51) Int. Cl. G06Q 20/34; G06Q 30/0251; G06T 11/00

(52) U.S. Cl. CPC G06Q 20/355; G06Q 30/0269; G06T 11/00

(57) ABSTRACT

In some embodiments, a computer-implemented method, includes capturing, for a payment network associated with a payment card of a user of a digital platform, context-aware image generation data; generating, at the payment network associated with the payment card, a context-based personalized prompt based upon the context-aware image generation data, the context-based personalized prompt being associated with the user of the digital platform; utilizing the context-based personalized prompt to generate a context-aware image, the context-aware image being a transformer-based context aware image; and providing the context-aware image to the digital platform for dynamic view by the user of the digital platform. In some embodiments, the computer-implemented method further includes transforming the context-based personalized prompt into a context-based text embedding in order for the context-aware image to serve as the transformer-based context aware image.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

Digital marketing has become a dominant form of advertising on digital platforms due to the proliferation of internet usage in the interconnected world of today. Digital marketing enables businesses to reach a global audience on digital platforms, enhances engagement and brand perception, and tracks responses to ads in real-time through various channels, such as, for example, social media, email, search engines, and websites. Although the use of digital marketing improves customer retention and loyalty, current digital marketing campaigns often face challenges. For example, traditional online advertising methods tend to utilize static ads that do not engage the user or encourage customer and advertiser interaction. Furthermore, a majority of advertisements on digital platforms are not personalized or targeted to specific individuals and lack user appeal, which may lead users to ignore or skip ads, leading to lower click-through rates and overall ineffectiveness. Therefore, a need exists to provide digital marketing systems that improve user engagement and effectiveness.

### BRIEF DESCRIPTION OF THE DRAWINGS

FIG. 1 illustrates a block diagram of a system in accordance with some embodiments.

FIG. 2 illustrates a block diagram of a payment network and a digital platform server in accordance with some embodiments.

FIG. 3 illustrates a block diagram of a context-aware image generation system of FIG. 1 in accordance with some embodiments.

FIG. 4 illustrates an example operation of a context-based pairing unit of FIG. 3 in accordance with some embodiments.

FIG. 5 is a flow diagram illustrating a method for generating context-aware images using a context-aware image generation system in accordance with some embodiments.

### DETAILED DESCRIPTION

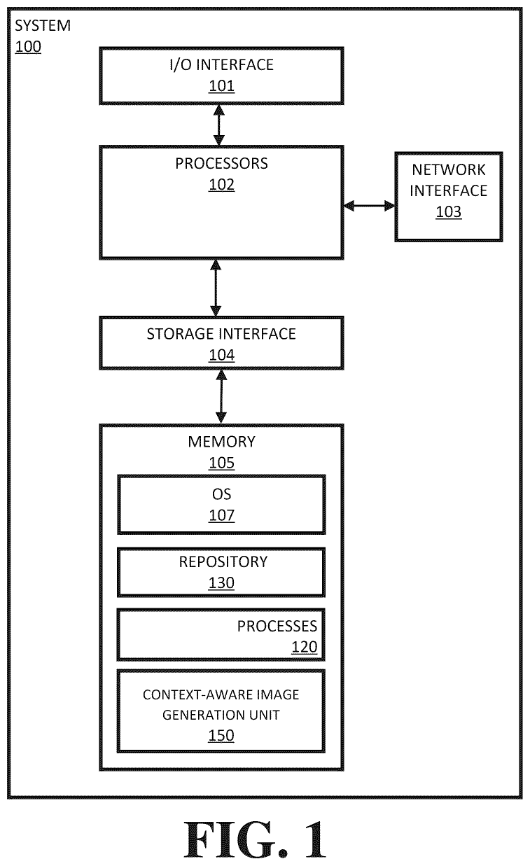

FIG. 1 illustrates a block diagram of an exemplary system 100 for implementing embodiments consistent with the present disclosure. In some nonlimiting embodiments or aspects, the system 100 may utilize a context-aware image generation system 150 to implement a method for generating context-aware images. In some embodiments, the processor/s 102 may comprise at least one data processors for executing program components for dynamic resource allocation at run time. The processors 102 may include specialized processing units such as integrated system (bus) controllers, memory management control units, floating point units, graphics processing units, digital signal processing units, etc.

In some embodiments, the processors 102 may be disposed in communication with one or more input/output (I/O) devices (not shown) via an I/O interface 101. The I/O interface 101 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMi), RF antennas, S-Video, VGA, IEEE 802.1 n/b/g/n/x, Bluetooth®, cellular (e.g., code-division multiple access (CDMA), high-speed packet access (HSPA+), global system for mobile communications (GSM), long-term evolution (LTE), WiMax®, or the like), etc.

In some embodiments, using the I/O interface 101, the system 100 may communicate with one or more I/O devices. For example, an input device 110 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. An output device 111 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the processors 102 may be disposed in communication with a communication network via a network interface 103. The network interface 103 may communicate with the communication network. The network interface 103 may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network may include, without limitation, a direct interconnection, e-commerce network, a peer to peer (P2P) network, local area network (LAN), wide area network (WAN), wireless network (e.g., using Wireless Application Protocol), the internet, Wi-Fi®, etc. Using the network interface 103 and the communication network, the system 100 may communicate with the one or more service operators or other computers.

In some non-limiting embodiments or aspects, the processors 102 may be disposed in communication with a memory 105 (e.g., RAM, ROM, etc.) via a storage interface 104. In some embodiments, the storage interface 104 may connect to memory 105 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems interface (SCSI), etc. The memory drives may further include a drum, magnetic disc drive, magneto-optical drive, optical drive, Redundant Array of Independent Discs (RAID), solid-state memory devices, solid-state drives, etc.

In some embodiments, memory 105 may store a collection of program or database components, including, without limitation, a user interface, an operating system 107, a data repository 130, a web server, processes 120, context-aware image generation system 150, etc., described further in detail herein. In some non-limiting embodiments or aspects, the system 100 may store user/application data, such as the data, variables, records, context-aware image generation data 310, etc. as described in this disclosure. Such databases may be implemented as fault-tolerant, relational, scalable, secure databases such as Oracle or Sybase and/or a non-relational base, such as NoSQL.

In some embodiments, the operating system 107 may facilitate resource management and operation of the system 100. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® OS®, GOOGLE™ ANDROID™, BLACKBERRY® OS, or the like.

In some non-limiting embodiments or aspects, the system 100 may implement a web browser (not shown in the figures) stored program component. The web browser (not shown in the figures) may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers may utilize facilities such as AJAX, DHTML, ADOBE® FLASH®, JAVASCRIPT®, JAVA®, Application Programming Interfaces (APIs), etc.

Furthermore, one or more computer-readable storage media may be utilized in implementing embodiments consistent with the present disclosure. In some embodiments, a computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, e.g., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

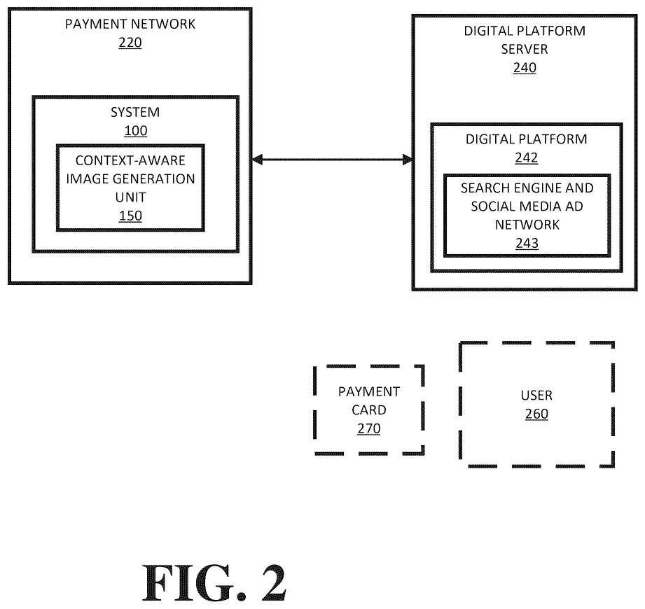

FIG. 2 illustrates a block diagram of a payment network 220 and a digital platform server 240. In some embodiments, the payment network 220 includes system 100 communicatively coupled to digital platform server 240. In some embodiments, the digital platform server 240 includes digital platform 242 that is utilized by a user 260 of digital platform 242 to view context-aware image 152 and communicate digitally via digital platform 242. In some embodiments, user 260 is a user of digital platform 242 and a payment card 270 that is associated with payment network 220. In some embodiments, user 260 (e.g., a person) utilizes digital platform 242 for social networking, internet services, purchasing merchandise, etc., In some embodiments, user 260 may utilize payment card 270 (or digital equivalent dynamically displayed as part of context-aware image 152) to purchase merchandise on digital platform 242. In some embodiments, the digital platform 242 is a social network configured to be communicatively coupled to payment network 220 to allow payment network 220 to utilize context-aware image generation system 150 to display a context-aware image generated by context-aware image generation system 150. In some embodiments, the digital platform 242 may be, for example, a social network, such as, Instagram®, TikTok®, Facebook®, etc. In some embodiments, the digital platform 242 collects user information 317 about user 260 of digital platform 242. In some embodiments, the user information 317 may be, for example, user platform engagement metrics are utilized to generate context-aware image 152. In some embodiments, user platform engagement metrics are user platform engagement metrics collected by digital platform 242 that may be used by context-aware image generation system 150 to generate context-aware image 152. In some embodiments, the user platform engagement metrics are collected by digital platform 242 and provided to context-aware image generation system 150 as part of reinforcement learning feedback, described further herein. In some embodiments, the user platform engagement metrics are collected periodically by digital platform 242. As stated previously, context-aware image generation system 150 may utilize the user platform engagement metrics to generate context-aware image 152, described further in detail herein.

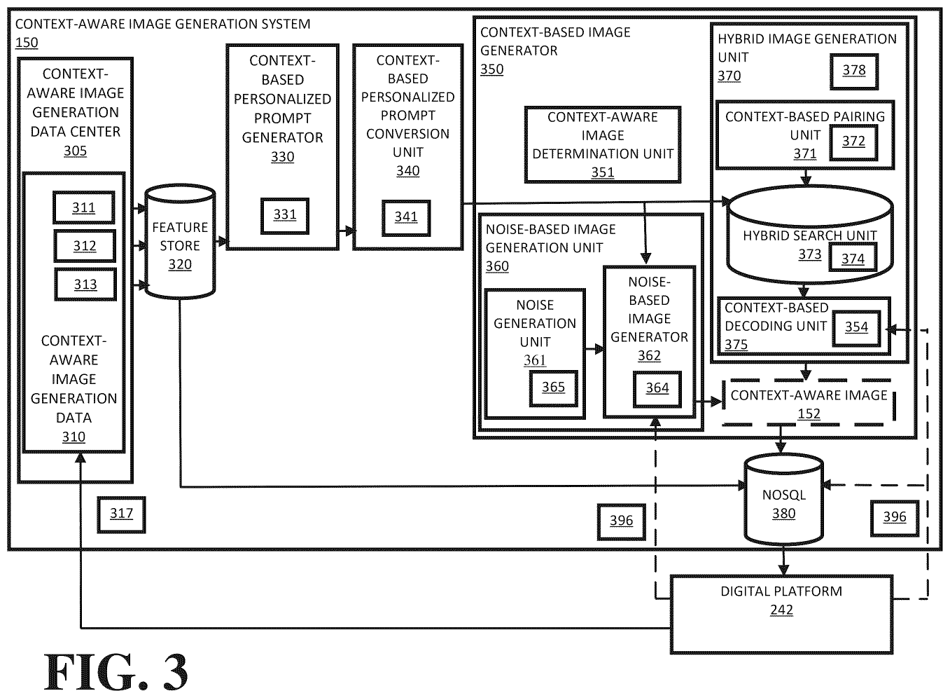

FIG. 3 illustrates a block diagram of a context-aware image generation system 150 and digital platform 242 of FIG. 1 in accordance with some embodiments. In some embodiments, context-aware image generation system 150 includes, in addition to the hardware required to execute the context-aware image generation system 150, executable code configured to generate context-aware image 152. In some embodiments, the context-aware image generation system 150 includes a context-aware image generation data center 305, a feature store 320, a context-based personalized prompt generator 330, a context-based personalized prompt conversion unit 340, a context-based image generator 350, and a NoSQL 380. In some embodiments, context-aware image generation system 150 utilizes context-aware image generation data center 305, feature store 320, context-based personalized prompt generator 330, context-based personalized prompt conversion unit 340, context-based image generator 350, and NoSQL 380 to generate context-aware image 152, described further herein.

In some embodiments, in operation, feature store 320 of context-aware image generation system 150 receives context-aware image generation data 310 from context-aware image generation data center 305 to commence the process of generating context-aware image 152. In some embodiments, context-aware image generation data center 305 is executable code and associated hardware configured to collect and provide context-aware image generation data 310 to feature store 320 to generate context-aware image 152. In some embodiments, context-aware image generation data center 305 collects and receives a portion of the context-aware image generation data 310 and other information, such as, for example, user information, from digital platform 242. In some embodiments, context-aware image generation data 310 is data associated with a user of digital platform 242 that is utilized by context-aware image generation system 150 to generate context-aware image 152. In some embodiments, the user of the digital platform 242 is a payment card user associated with a payment card (e.g., VISAR credit card, etc.) that may be presented digitally as part of context-aware image 152 for use on digital platform 242 and processed by payment network 220 during a purchase of, for example, goods or services on digital platform 242. In some embodiments, the context-aware image generation data 310 may include user platform engagement metrics. As stated previously, user platform engagement metrics are user platform engagement metrics collected by digital platform 242 for use by context-aware image generation system 150 to generate context-aware image 152. In some embodiments, context-aware image generation data 310 includes, for example, input parameters 311, demographic data 312, and profile data 313. In some embodiments, profile data 313 is data associated with a profile of a user of a payment card 270 (e.g., user 260) associated with payment network 220 and digital platform 242. In some embodiments, profile data 313 may include, for example, a user ID, a user name, a user email ID associated with user 260, and communication medium information (e.g., social media platform information, search engine information, etc. associated with digital platform 242). In some embodiments, demographic data 312 is demographic data, such as, for example, statistical demographic data, that maps to characteristics of a population associated with a user of payment card 270 associated with payment network 220. For example, in some embodiments, demographic data 312 includes, an age of a population associated with a user of payment card 270, a gender of a population associated with a user of payment card 270, an occupation of a population associated with a user of payment card 270, a nationality of a population associated with a user of payment card 270, a geographic location of a population associated with a user of payment card 270, an income of a population associated with a user of payment card 270, values of a population associated with a user of payment card 270, and/or hobbies of a population associated with a user of payment card 270.

In some embodiments, input parameters 311 are feed data associated with a user of payment card 270 associated with payment network 220. In some embodiments, input parameters 311 may include, for example, a current time that user 260 of digital platform 242 is utilizing digital platform 242, a current season that user 260 of digital platform 242 is utilizing digital platform 242, a current weather at the location that user 260 of digital platform 242 is utilizing digital platform 242, a type of digital platform that is being utilized by user 260 associated with payment network 220, etc. In some embodiments, context-aware image generation data 310, e.g., the input parameters 311, demographic data 312, and profile data 313, may be in the form of context-aware feature vectors that are provided to feature store 320. In some embodiments, context-aware image generation data 310 may be labeled or unlabeled feature vectors that are provided to feature store 320. In some embodiments, context-aware image generation data 310 may be used to generate a context-based personalized prompt 331, which may be utilized to generate a personalized advertisement via context-aware image 152, described further herein.

In some embodiments, feature store 320 is a data structure configured to receive and store context-aware image generation data 310. In some embodiments, feature store 320 may be implemented on a standalone computer or server computer, or implemented on one or more computer systems that implement system 100. In some embodiments, as stated previously, the context-aware feature vectors utilized by feature store 320 may include feature vectors corresponding to context-aware image generation data 310 paired with classification data, e.g., a feature vector corresponding to context-aware image generation data 310. In some embodiments, the context-aware feature vectors stored in feature store 320 may additionally have corresponding labels, such as labels that are mapped to context-aware image generation data 310. In some embodiments, the context-aware feature vectors in feature store 320 may be used by system 100 to train a machine learning a model/s or validate a machine learning model/s stored in model cache of system 100. Additionally. system 100 may write received context-aware image generation data 310, along with corresponding classification data as labeled feature vectors to feature store 320. In some embodiments, after storing context-aware image generation data 310 as context-aware image feature vectors 321 in feature store 320, feature store 320 provides the context-aware image feature vectors 321 to context-based personalized prompt generator 330.

In some embodiments, context-based personalized prompt generator 330 receives context-aware image feature vectors 321 from feature store 320 and commences the process of generating context-based personalized prompt 331. In some embodiments, context-based personalized prompt generator 330 is executable code configured to generate a context-based personalized prompt 331 utilizing context-aware image feature vectors 321. In some embodiments, the context-based personalized prompt 331 is a prompt generated by context-based personalized prompt generator 330 that is utilized by context-based personalized prompt conversion unit 340 to generate context-based text embedding 341, described further in detail herein. In some embodiments, context-based personalized prompt generator 330 generates the context-based personalized prompt 331 by translating the context-aware image generation data 310 from the context-aware image feature vectors 321 into a context-based descriptive text format. In some embodiments, the context-based descriptive text format is a descriptive text format that conveys the context-aware image generation information to context-based personalized prompt conversion unit 340. In some embodiments, context-based personalized prompt generator 330 converts context-aware image feature vectors 321 into context-based personalized prompt 331 by translating, for example, numerical data and categorical data, etc., from the context-aware image feature vectors 321 into the descriptive text format that conveys context-aware image information to context-based personalized prompt conversion unit 340. In some embodiments, after generating the context-based personalized prompt 331, context-based personalized prompt generator 330 provides the context-based personalized prompt 331 to context-based personalized prompt conversion unit 340.

In some embodiments, context-based personalized prompt conversion unit 340 receives context-based personalized prompt 331 from context-based personalized prompt generator 330 of context-aware image generation system 150. In some embodiments, context-based personalized prompt conversion unit 340 is executable code configured to convert context-based personalized prompt 331 received from context-based personalized prompt generator 330 to context-based text embedding 341. In some embodiments, context-based text embedding 341 is a text embedding derived from context-based personalized prompt 331 that is utilized by noise-based image generation unit 360 and/or hybrid image generation unit 370 to generate context-aware image 152.

In some embodiments, context-based personalized prompt conversion unit 340 is configured to transform the context-based personalized prompt 331 into context-based text embedding 341 by utilizing a context-based transform model. In some embodiments, a context-based transform model is a machine learning model that transforms context-based personalized prompts into context-based text embedding 341. In some embodiments, context-based transform model transforms a context-based personalized prompt 331 to context-based text embedding 341 by tokenizing the context-based personalized prompt 331, converting the tokenized context-based personalized prompt 331 to context-based vectors, adding positional encodings to the context-based vectors, and processing the positional encodings through multiple layers of feedforward neural networks to generate high-dimensional contextual representations of the context-based personalized prompt 331. In some embodiments, after converting context-based personalized prompt 331 to context-based text embedding 341, context-based personalized prompt conversion unit 340 provides context-based text embedding 341 to noise-based image generation unit 360 and hybrid image generation unit 370 of context-based image generator 350 to generate context-aware image 152.

In some embodiments, context-based image generator 350 receives context-based text embedding 341 from context-based personalized prompt conversion unit 340 and commences the process of generating context-aware image 152. In some embodiments, context-based image generator 350 is executable code configured to generate context-aware image 152 utilizing noise-based image generation unit 360 and/or hybrid image generation unit 370. In some embodiments, noise-based image generation unit 360 is executable code configured to utilize noise-based image generator 362 and noise generation unit 361 to generate noise-based context-aware image 364, which may be represented as context-aware image 152. In some embodiments, hybrid image generation unit 370 is executable code and associated hardware configured to utilize context-based pairing unit 371, hybrid search unit 373, and context-based decoding unit 375 to generate hybrid-generated context-aware image 354, which may also be represented as context-aware image 152, described further herein. In some embodiments, context-aware image 152 is a digital image whose content is configured to be dynamically adjusted by context-based image generator 350 utilizing noise-based image generation unit 360 and/or hybrid image generation unit 370. In some embodiments, context-aware image 152 may be dynamically adjusted based on, for example, user feedback and user preferences of a user of a digital platform 242. In some embodiments, context-based image generator 350 generates context-aware image 152 by utilizing noise-based image generation unit 360 and/or hybrid image generation unit 370 to adjust, for example, ad content in context-aware image 152 based on user feedback and adaptable or changing user preferences. In some embodiments, utilization of the context-aware image 152 generated by context-aware image generation system 150 ensures improvement over other image generation systems in that marketing content remains instantaneously relevant, up-to-date, and effective for users (e.g., consumers and viewers) of digital platform 242 and payment card 270 that are viewing context-aware image 152, thereby reducing the need for additional software or hardware to perform similar operations.

In some embodiments, with reference to noise-based image generation unit 360, noise-based image generator 362 of noise-based image generation unit 360 receives context-based text embedding 341 from context-based personalized prompt conversion unit 340 and noise 365 from noise generation unit 361 and commences the process of generating noise-based context-aware image 364 as context-aware image 152. In some embodiments, noise-based image generator 362 is executable code configured to generate context-aware image 152 utilizing noise 363 generated by noise generation unit 361 and context-based text embedding 341 provided from context-based personalized prompt conversion unit 340. In some embodiments, noise generation unit 361 is executable code configured to generate noise 365 that is provided to noise-based image generator 362 to generate noise-based context-aware image 364 as context-aware image 152. In some embodiments, the noise 365 generated by noise generation unit 361 may be in the form of, for example, gaussian noise.

In some embodiments, noise-based image generator 362 generates noise-based context-aware image 364 by utilizing a context-aware-configured diffusion model that is configured to generate noise-based context-aware image 364 utilizing noise 365 and context-based text embedding 341. In some embodiments, a context-aware-configured diffusion model is a probabilistic machine learning system that is configured to utilize a generative model that is designed to generate noise-based context-aware image 364, including associated text, audio, and video. The context-aware-configured diffusion model utilizes iteration to refine noisy inputs by progressively denoising the data associated with the received images, text, or audio through a learned sequence of transformations that reverse an initial noise addition process and mapping noise to coherent data representations. In some embodiments, noise-based image generator 362 trains the generative model by destroying training data through successive addition of, for example, noise 365 (e.g., gaussian noise) from noise generation unit 361 and utilizing a reverse denoising process to learn to recover the associated training data. In some embodiments, noise-based image generator 362 utilizes the context-aware-diffusion model to generate the noise-based context-aware image 364 and continuously convert the noise-based context-aware image 364 into a high-resolution noise-based context-aware image 364. In some embodiments, noise-based image generation unit 360 provides the noise-based context-aware image 364 as context-aware image 152 to NoSQL 380, which is utilized by digital platform server 240 for dynamic display on digital platform 242. In some embodiments, as the context-based personalized prompt 331 and the resulting context-based text embedding 341 is customized for a particular user (e.g., user 260), the context-aware image 152 generated by noise-based image generation unit 360 is also customized for user 260, thereby enhancing and improving the customization experience for the user 260 of digital platform 242 and serving as an example of a practical application of the context-based image generator 350.

Similarly, in some embodiments, noise-based image generator 362 may utilize a denoising diffusion probabilistic decoder model to create an object (e.g., digital image, audio, and/or video) commencing with noise 365 and transform the object into an output object. In some embodiments, noise-based image generator 362 may utilize an object-generation model to guide the image generation process and receives a text encoding of text associated with the context-based personalized prompt 331 as an input signal to initiate generation of the image. For example, noise-based image generator 362 may receive text encoding associated with a context-based personalized prompt 331 that states “Generate an image of a Visa Platinum card from ABC Bank with some image of La Union Cowboys football club on the card and background containing some scenic monsoon”. In some embodiments, receipt of the text encoding of the context-based personalized prompt 331 instructs the object-generation model as to the content of the context-based personalized prompt 331, thereby allowing object-generation model and noise-based image generator 362 to create a corresponding noise-based context-aware image 364. In some embodiments, an initial output image generated by noise-based image generator 362 may be a minimal resolution which may be passed to, for example, a super-res model in noise-based image generator 362 to generate a high-resolution noise-based context-aware image 364. In some embodiments, noise-based image generation unit 360 provides the noise-based context-aware image 364 as context-aware image 152 to NoSQL 380.

In some embodiments, with reference to hybrid image generation unit 370, hybrid search unit 373 of hybrid image generation unit 370 receives the context-based text embedding 341 from context-based personalized prompt conversion unit 340 and optionally, reinforcement learning feedback 396 from digital platform 242 and commences the process of generating context-aware image 152. In some embodiments, reinforcement learning feedback 396 is user platform engagement metric feedback (e.g., user click volume information, etc.) provided from digital platform 242 (e.g., search engine and social media ad network 243) that may be utilized by noise-based image generation unit 360 and/or hybrid image generation unit 370 of context-based image generator 350 to generate an advertisement efficacy measurement, described further in detail herein.

In some embodiments, in order to commence the process of generating context-aware image 152, hybrid image generation unit 370 prepares a context-based pair training dataset 378 for use by context-based pairing unit 371 in generating a context-based paired embedding 372, described further herein. In some embodiments, context-based pair training dataset 378 is a training dataset of context-based pairs (e.g., text+object pair)) utilized by context-based pairing unit 371 to generate a context-based paired embedding 372. In some embodiments, context-based image generator 350 prepares the training dataset for use by context-based pairing unit 371 by collecting, consolidating, and placing the text and object pairs in the appropriate order and format required for context-based pairing unit 371. In some embodiments, hybrid image generation unit 370 provides the context-based pair training dataset 378 to context-based pairing unit 371.

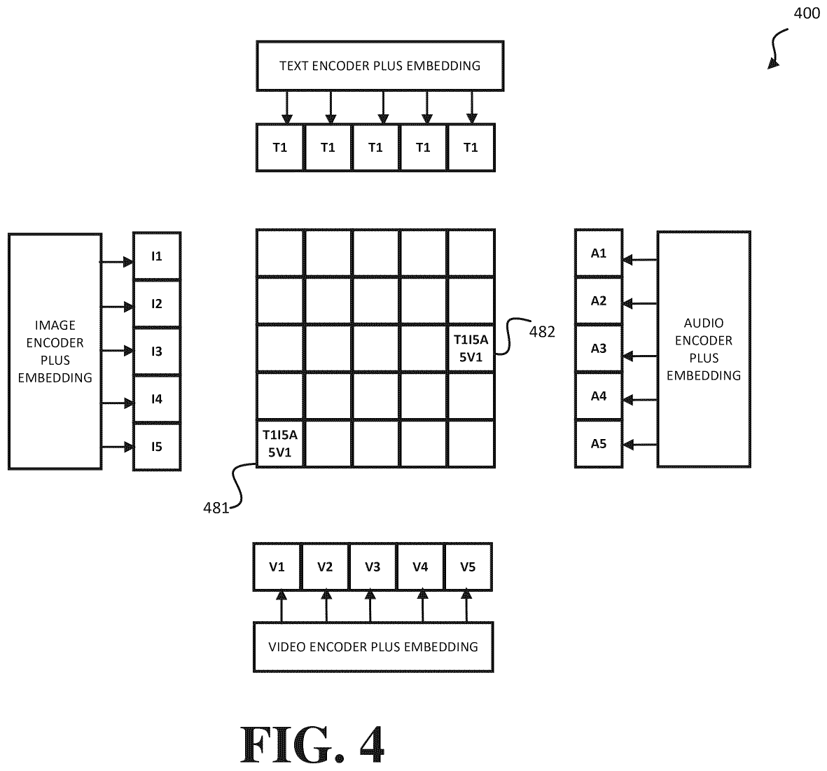

In some embodiments, context-based pairing unit 371 receives the context-based pair training dataset 378 and commences the process of generating context-based paired embedding 372. In some embodiments, context-based pairing unit 371 is executable code configured to generate context-based paired embedding 372 for use by hybrid search unit 373 in generating unified context-aware image embedding 374, described further herein. In some embodiments, context-based paired embedding 372 is an embedded pair of text and images, audio, and/or video that are utilized by hybrid image generation unit 370 to dynamically enhance a background of hybrid-generated context-aware image 354. In some embodiments, the object may be, for example, a digital image, audio, and/or video that is utilized to generate context-based paired embedding 372. In some embodiments, context-based pairing unit 371 generates context-based paired embedding 372 by utilizing a series of encoders to combine text with an object (e.g., digital image, audio, and/or video). For example, context-based pairing unit 371 generates context-based pair embedding 372 by utilizing an encoding architecture (an encoder for text and an encoder for image, and optionally an audio encoder and/or video encoder), as illustrated operationally by way of example in FIG. 4.

For example, in some embodiments, in order to generate context-based paired embedding 372 that corresponds to a text and image combination, a text encoder and an image encoder are used in combination to generate text and image pair context-based paired embedding 372. In some embodiments, context-based pairing unit 371 combines the text and image by encoding each (e.g., the text and image) into vector representations using their respective encoders and projecting the vectors into a shared latent space. In some embodiments, utilizing the shared latent space, the similarity or relevance of the vectors may be measured using, for example, cosine similarity or dot product techniques. In some embodiments, the context-based paired embedding 372 may be created using text associated with a pre-configured image and object pair provided by a businesses or clients as a standard for a product. For example, an issuer of payment card 270 may provide images of multiple payment cards (e.g., credit and/or debit cards) and a description of the images and advertisement offers as text. In some embodiments, the text and object pairs are transformed to context-based paired embedding 372 using text and image encoding respectively and stored in vector form in hybrid search unit 373.

Similarly, in some embodiments, in order to generate context-based paired embedding 372 that corresponds to audio and image combination, an audio encoder and an image encoder may be used in combination to generate audio and image pair context-based paired embedding. Similarly, to generate context-based paired embedding that corresponds to an audio and video combination, an audio encoder and a video encoder may be used in combination to generate the audio and video pair context-based paired embedding. In some embodiments, the decision as to which combination to utilize to generate the hybrid-generated context-aware image 354 is based on the prevalence of the required text, audio, video, or image available for combination to generate the desired context-based paired embedding 372. In some embodiments, after generating context-based paired embedding 372, context-based pairing unit 371 provides context-based paired embedding 372 to hybrid search unit 373.

In some embodiments, hybrid search unit 373 receives context-based paired embedding 372 from context-based pairing unit 371 and context-based text embedding 341 from context-based personalized prompt conversion unit 340 and commences the process of generating unified context-aware image embedding 374. In some embodiments, hybrid search unit 373 is a composite embedding store that utilizes executable code configured to perform a hybrid search to generate unified context-aware image embedding 374. In some embodiments, hybrid search unit 373 may utilize context-based text embedding 341 and context-based paired embedding 372 to generate unified context-aware image embedding 374. In some embodiments, hybrid search unit 373 performs the hybrid search by performing a hybrid search comparison of the context-based text embedding 341 and context-based paired embedding 372. In some embodiments, the context-based paired embedding 372 (e.g., joint embeddings) generated by context-based pairing unit 371 are stored by hybrid search unit 373 and indexed for use in executing the hybrid search. In some embodiments, hybrid search unit 373 may utilize a fusion of keyword-based and vector search techniques to perform the hybrid search.

In some embodiments, hybrid search unit 373 is configured to operate as a composite embedding store and generate a unified context-aware image embedding 374 by utilizing a plurality of context-based pair embeddings (e.g., a plurality of context-based pair embedding 372) to generate a context-based pair embedding quartlet. In some embodiments, hybrid search unit 373 generates the context-based pair embedding quartlet by finding matching pairs with a minimal distance/similarity metric between the pairs and maximizing the distance between non-matching pairs. In some embodiments, the context-based pair embedding quartlet is utilized by hybrid search unit 373 to create consolidated embeddings (e.g., unified context-aware image embedding 374) in the hybrid search unit 373. That is, hybrid search unit 373 performs a hybrid similarity search on contextually created embedding to find the nearest neighboring embedding and selects the most appropriate contextually created embedding as unified context-aware image embedding 374 (which may be utilized by context-based decoding unit 375 to construct an object when generating context-aware image 152). In some embodiments, hybrid search unit 373 stores the unified context-aware image embedding 374 in a unified context-aware image format and provides the unified context-aware image embedding 374 (e.g., unified context-aware image joint embedding) to context-based decoding unit 375.

In some embodiments, context-based decoding unit 375 receives the unified context-aware image embedding 374 from hybrid search unit 373 and commences the process of generating hybrid-generated context-aware image 354. In some embodiments, context-based decoding unit 375 is executable code configured to decode the unified context-aware image embedding 374 to generate hybrid-generated context-aware image 354. In some embodiments, context-based decoding unit 375 generates the hybrid-generated context-aware image 354 by using the unified context-aware image embedding 374 to reconstruct and generate hybrid-generated context-aware image 354. In some embodiments, the hybrid-generated context-aware image 354 generated by context-based decoding unit 375 is configured to match the features encoded in the unified context-aware image embedding 374. In some embodiments, context-based decoding unit 375 processes the unified context-aware image embedding 374 through a series of layers and operations designed to translate the abstract features of the unified context-aware image embedding 374 into hybrid-generated context-aware image 354. In some embodiments, the series of layers or operations may include, for example, upsampling, applying convolutional layers, and other techniques utilized to produce a hybrid-generated context-aware image 354 that aligns with the content of the unified context-aware image embedding 374. In some embodiments, context-based decoding unit 375 may utilize a generative model, such as, for example, a Generative Adversarial Network (GAN) or Variational Autoencoder (VAE)), that receives the unified context-aware image embedding 374 as input and generates hybrid-generated context-aware image 354. In some embodiments, after generating context-aware image 152, context-based decoding unit 375 provides hybrid-generated context-aware image 354 as context-aware image 152 to NoSQL 380 for dynamic display by digital platform 242.

In some embodiments, NoSQL 380 receives context-aware image 152 and commences the process of providing context-aware image 152 to digital platform 242 for dynamic display. In some embodiments, NoSQL 380 is a non-relational database configured to store context-aware image 152 and other large volumes of unstructured or semi-structured data provided from, for example, feature store 320 and/or digital platform 242 for context-aware image generation system 150. For example, NoSQL 380 is configured to store, for a user 260 of digital platform 242, basic details, such as, for example, email, image IDs associated with context-aware images generated for user 260, as well as the context-aware images previously generated for user 260, in addition to other profile data necessary to integrate with online advertising platforms. In some embodiments, once context-aware image 152 has been generated by context-based image generator 350 and stored in NoSQL 380, NoSQL 380 provides context-aware image 152 to digital platform 242 for dynamic view by user 260.

In some embodiments, optionally, noise-based image generation unit 360 and/or hybrid image generation unit 370 of context-based image generator 350 may be configured to utilize reinforcement learning feedback 396 to dynamically adjust context-aware image 152. For example, noise-based image generation unit 360 and/or hybrid image generation unit 370 of context-based image generator 350 may be configured to generate an advertisement efficacy measurement of an advertisement on display on context-aware image 152 and utilize the advertisement efficacy measurement to dynamically adjust context-aware image 152. In some embodiments, the advertisement efficacy measurement is a measurement of effectiveness of an advertisement displayed on context-aware image 152. As stated previously, in some embodiments, reinforcement learning feedback 396 is user platform engagement metric feedback (e.g., user click volume information, etc.) provided from digital platform 242 (e.g., search engine and social media ad network 243) that may be utilized by noise-based image generation unit 360 and/or hybrid image generation unit 370 of context-based image generator 350 to generate an advertisement efficacy measurement. In some embodiments, digital platform 242 may provide user platform engagement metric feedback (e.g., user click volume information, click-rate information, etc.) to context-based image generator 350 and the advertisement efficacy measurement may be taken by measuring the number of clicks performed by the user associated with context-aware image 152. In some embodiments, when, for example, a user clicks on an ad display in context-aware image 152, noise-based image generation unit 360 and/or hybrid image generation unit 370 may fine tune the context-aware image 152 generated to include the type of ad that correlates with an elevated advertisement efficacy measurement (e.g., an advertisement efficacy measurement greater than an advertisement efficacy measurement threshold assigned by the context-based image generator 350) and include the ad in a newly generated context-aware image 152.

In some embodiments, with further reference to context-based image generator 350, in order to determine whether hybrid-generated context-aware image 354 or noise-based context-aware image 364 is generated as context-aware image 152 (by either noise-based image generation unit 360 and/or hybrid image generation unit 370), context-based image generator 350 utilizes a context-aware image determination unit 351. In some embodiments, context-aware image determination unit 351 is executable code configured to determine whether hybrid-generated context-aware image 354 and/or noise-based context-aware image 364 is utilized as context-aware image 152. In some embodiments, context-aware image determination unit 351 determines whether hybrid-generated context-aware image 354 and/or noise-based context-aware image 364 is utilized as context-aware image 152 by determining whether the combined text and embedding associated with the output of context-based personalized prompt conversion unit 340 (e.g., context-based text embedding 341) is closely matched with combined text and embeddings stored in hybrid search unit 373. In some embodiments, when context-aware image determination unit 351 determines that the combined text and embedding associated with the output of context-based personalized prompt conversion unit 340 is closely matched with combined text and embeddings stored in hybrid search unit 373, hybrid-generated context-aware image 354 is generated as context-aware image 152. In some embodiments, when context-aware image determination unit 351 determines that the combined text and embedding associated with the output of context-based personalized prompt conversion unit 340 is not closely matched with combined text and embeddings stored in hybrid search unit 373, noise-based context-aware image 364 is generated as context-aware image 152.

FIG. 4 illustrates an example visualization of operations 400 performed by context-based pairing unit 371 of FIG. 3 in accordance with some embodiments. As illustrated in FIG. 4, text, images, audio, and video associated with user 260 are encoded and contextually embedded to generate context-based paired embeddings. For example, to generate a context-based paired embedding (e.g., context-based paired embedding 481 and context-based paired embedding 482) that corresponds to a text, image, audio and video combination, a text encoder, an image encoder, an audio encoder, and a video encoder are utilized in combination to generate the text, image, audio and video context-based paired embedding (e.g., context-based paired embedding 481 and context-based paired embedding 482). In some embodiments, context-based pairing unit 371 combines the text, image, audio, and video by encoding each (e.g., represented as T1-T5, I1-I5, A1-A5, V1-V5, respectively) into vector representations using the respective encoders and projecting the vectors into a shared latent space (e.g., T1I5A5V1 and T1I5A5V1 as illustrated by way of example in FIG. 4) where the embedding similarity or relevance may be measured by hybrid image generation unit 370, as discussed previously with reference to FIG. 3.

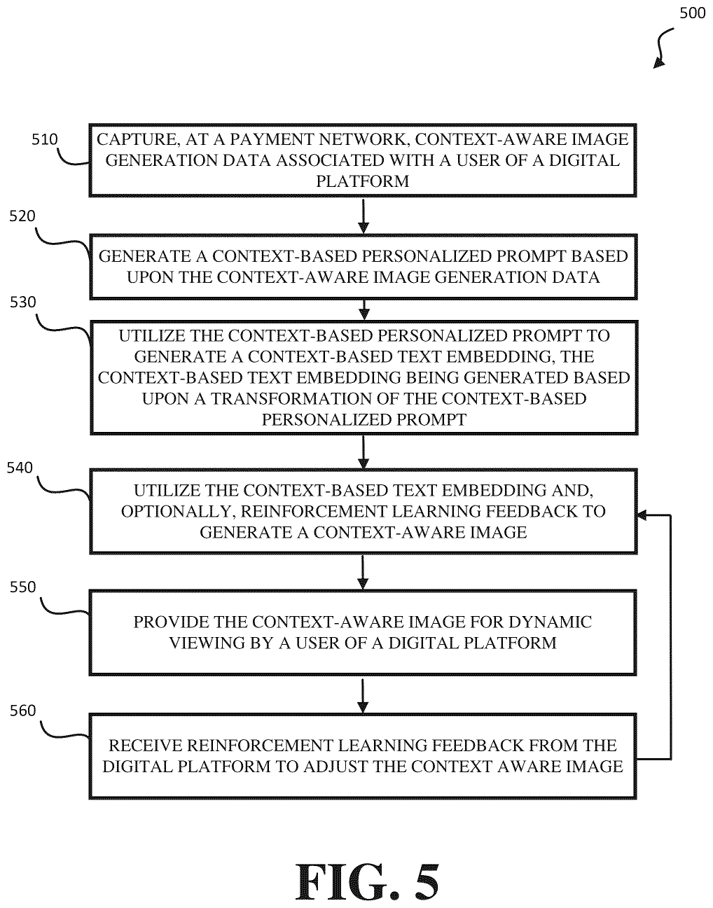

FIG. 5 illustrates a method 500 for generating context-aware images utilizing the context-aware image generation system 150 of FIG. 1 in accordance with some embodiments. The method, process steps, or stages illustrated in FIG. 5 may be implemented as an independent routine or process, or as part of a larger routine or process. Note that each process step or stage depicted may be implemented as an apparatus that includes a processor executing a set of instructions, a method, or a system, among other embodiments. In some embodiments, method 500 is described with reference to FIG. 1-FIG. 5.

In some embodiments, with reference to FIGS. 1-5, at block 510, context-aware image generation data center 305 of payment network 220 captures and/or receives context-aware image generation data 310. In some embodiments, the context-aware image generation data 310 may include, for example, user platform engagement metrics associated with user 260 and digital platform 241 and payment transaction details associated with payment card 270.

In some embodiments, at block 520, context-based personalized prompt generator 330 generates context-based personalized prompt 331. In some embodiments, context-based personalized prompt generator 330 generates context-based personalized prompt 331 based upon context-aware image generation data 310 received from context-aware image generation data center 305.

In some embodiments, at block 530, context-based personalized prompt conversion unit 340 utilizes the context-based personalized prompt 331 generated by context-based personalized prompt generator 330 to generate context-based text embedding 341. As stated previously, context-based personalized prompt conversion unit 340 is configured to transform the context-based personalized prompt 331 into context-based text embedding 341 by utilizing a context-based transform model, described previously with reference to FIG. 3.

In some embodiments, at block 540, context-based image generator 350 utilizes context-based text embedding 341 and optionally, reinforcement learning feedback 396 provided from digital platform 242 to generate context-aware image 152. In some embodiments, at block 550, context-aware image generation system 150 provides context-aware image 152 to digital platform 242 for dynamic and personalized viewing by user 260 of digital platform 242. In some embodiments, at block 560, context-based image generator 350 receives reinforcement learning feedback 396 from digital platform 242 to optionally adjust context-aware image 152.

In some embodiments, a computer-implemented method, includes capturing, for a payment network associated with a payment card of a user of a digital platform, context-aware image generation data; generating, at the payment network associated with the payment card, a context-based personalized prompt based upon the context-aware image generation data, the context-based personalized prompt being associated with the user of the digital platform; utilizing the context-based personalized prompt to generate a context-aware image, the context-aware image being a transformer-based context aware image; and providing the context-aware image to the digital platform for dynamic view by the user of the digital platform.

In some embodiments, the computer-implemented method further includes transforming the context-based personalized prompt into a context-based text embedding in order for the context-aware image to serve as the transformer-based context aware image.

In some embodiments, the computer-implemented method further includes utilizing the context-based text embedding to optionally generate a noise-based context-aware image as the context aware image.

In some embodiments, the computer-implemented method further includes utilizing the context-based text embedding to optionally generate a hybrid-generated context-aware image.

In some embodiments, the computer-implemented method further includes, when the noise-based context-aware image is selected as being generated as the context aware image, utilizing noise to generate the noise-based context-aware image.

In some embodiments, the computer-implemented method further includes, when the hybrid-generated context-aware image is selected as being generated as the context aware image, generating a context-based paired embedding.

In some embodiments, the computer-implemented method further includes, when the context-based paired embedding is generated, utilizing the context-based paired embedding to generate a unified context-aware image embedding.

In some embodiments, the computer-implemented method further includes, when the unified context-aware image embedding is generated, utilizing the unified context-aware image embedding to generate the hybrid-generated context-aware image.

In some embodiments, the computer-implemented method further includes utilizing reinforcement learning feedback to generate the context-aware image.

In some embodiments, the computer-implemented method further includes leveraging the context-aware image to target advertisements specific to the user based on the context-based personalized prompt.

In some embodiments, a system includes a processor; and a non-transitory computer readable medium coupled to the processor, the non-transitory computer readable medium including code that: captures, for a payment network associated with a payment card of a user of a digital platform, context-aware image generation data; generates, at the payment network associated with the payment card, a context-based personalized prompt based upon the context-aware image generation data, the context-based personalized prompt being associated with the user of the digital platform; utilizes the context-based personalized prompt to generate a context-aware image, the context-aware image being a transformer-based context aware image; and provides the context-aware image to the digital platform for dynamic view by the user of the digital platform.

In some embodiments, the system includes code that: transforms the context-based personalized prompt into a context-based text embedding in order for the context-aware image to serve as the transformer-based context aware image.

In some embodiments, the system includes code that: utilizes the context-based text embedding to generate a noise-based context-aware image as the context aware image or a hybrid-generated context-aware image.

In some embodiments, the system includes code that, when the noise-based context-aware image is selected as being generated as the context aware image, utilizes noise to generate the noise-based context-aware image.

In some embodiments, the system includes code that, when the hybrid-generated context-aware image is selected as being generated as the context aware image, generates a context-based paired embedding.

In some embodiments, the system includes code that, when the context-based paired embedding is generated, utilizes the context-based paired embedding to generate a unified context-aware image embedding.

In some embodiments, the system includes code that, when the unified context-aware image embedding is generated, utilizes the unified context-aware image embedding to generate the hybrid-generated context-aware image.

In some embodiments, a method includes receiving, at a payment network associated with a payment card, payment card design details associated with the payment card of a user of a digital platform; capturing user platform engagement metrics and user payment transaction details associated with the user of the digital platform; generating, based on the user platform engagement metrics, the payment card design details, and the user payment transaction details, a context-based personalized prompt associated with the user of the digital platform; and generating, at the payment network of the payment card, a context-aware image associated with the payment card on the digital platform for use by the user of the digital platform.

In some embodiments of the method, the context-aware image associated with the payment card is a transformer-based context aware image.

In some embodiments of the method, the transformer-based context aware image is generated based on the context-based personalized prompt.

What is claimed is:

1. A computer-implemented method, comprising:
capturing, for a payment network associated with a payment card of a user of a digital platform, context-aware image generation data;
generating, at the payment network associated with the payment card, a context-based personalized prompt based upon the context-aware image generation data, the context-based personalized prompt being associated with the user of the digital platform;
utilizing the context-based personalized prompt to generate a context-aware image, the context-aware image being a transformer-based context aware image; and
providing the context-aware image to the digital platform for dynamic view by the user of the digital platform.

2. The computer-implemented method of claim 1, further comprising:
transforming the context-based personalized prompt into a context-based text embedding in order for the context-aware image to serve as the transformer-based context aware image.

3. The computer-implemented method of claim 2, further comprising:
utilizing the context-based text embedding to optionally generate a noise-based context-aware image as the context aware image.

4. The computer-implemented method of claim 3, further comprising:
utilizing the context-based text embedding to optionally generate a hybrid-generated context-aware image.

5. The computer-implemented method of claim 4, further comprising:
when the noise-based context-aware image is selected as being generated as the context aware image, utilizing noise to generate the noise-based context-aware image.

6. The computer-implemented method of claim 5, further comprising:
when the hybrid-generated context-aware image is selected as being generated as the context aware image, generating a context-based paired embedding.

7. The computer-implemented method of claim 6, further comprising:
when the context-based paired embedding is generated, utilizing the context-based paired embedding to generate a unified context-aware image embedding.

8. The computer-implemented method of claim 7, further comprising:
when the unified context-aware image embedding is generated, utilizing the unified context-aware image embedding to generate the hybrid-generated context-aware image.

9. The computer-implemented method of claim 8, further comprising:
utilizing reinforcement learning feedback to generate the context-aware image.

10. The computer-implemented method of claim 9, further comprising:
leveraging the context-aware image to target advertisements specific to the user based on the context-based personalized prompt.

11. A system, comprising:
a processor; and
a non-transitory computer readable medium coupled to the processor, the non-transitory computer readable medium including code that:
captures, for a payment network associated with a payment card of a user of a digital platform, context-aware image generation data;
generates, at the payment network associated with the payment card, a context-based personalized prompt based upon the context-aware image generation data, the context-based personalized prompt being associated with the user of the digital platform;
utilizes the context-based personalized prompt to generate a context-aware image, the context-aware image being a transformer-based context aware image; and
provides the context-aware image to the digital platform for dynamic view by the user of the digital platform.

12. The system of claim 11, further comprising code that:
transforms the context-based personalized prompt into a context-based text embedding in order for the context-aware image to serve as the transformer-based context aware image.

13. The system of claim 12, further comprising code that:
utilizes the context-based text embedding to generate a noise-based context-aware image as the context aware image or a hybrid-generated context-aware image.

14. The system of claim 13, further comprising code that:
when the noise-based context-aware image is selected as being generated as the context aware image, utilizes noise to generate the noise-based context-aware image.

15. The system of claim 14, further comprising code that:
when the hybrid-generated context-aware image is selected as being generated as the context aware image, generates a context-based paired embedding.

16. The system of claim 15, further comprising code that:
when the context-based paired embedding is generated, utilizes the context-based paired embedding to generate a unified context-aware image embedding.

17. The system of claim 16, further comprising code that:
when the unified context-aware image embedding is generated, utilizes the unified context-aware image embedding to generate the hybrid-generated context-aware image.

18. A method, comprising:
receiving, at a payment network associated with a payment card, payment card design details associated with the payment card of a user of a digital platform;
capturing user platform engagement metrics and user payment transaction details associated with the user of the digital platform;
generating, based on the user platform engagement metrics, the payment card design details, and the user payment transaction details, a context-based personalized prompt associated with the user of the digital platform; and
generating, at the payment network of the payment card, a context-aware image associated with the payment card on the digital platform for use by the user of the digital platform.

19. The method of claim 18, wherein:
the context-aware image associated with the payment card is a transformer-based context aware image.

20. The method of claim 19, wherein:
the transformer-based context aware image is generated based on the context-based personalized prompt.
